(19) United States
(12) Patent Application Publication
(10) Pub. No.: US 2007/0083782 A1
(43) Pub. Date: Apr. 12, 2007

(54) POWER CONFIGURATION SCHEME OF COMPUTER

(75) Inventor: TE-LIN PING, TAO-YUAN (TW)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignee: SILICON INTEGRATED SYSTEMS CORP., Hsin-Chu (TW)

(21) Appl. No.: 11/163,250

(22) Filed: Oct. 11, 2005

(51) Int. Cl. G06F 1/26

(52) U.S. Cl. 713/320

(57) ABSTRACT

A Power-saving method, which is able to configure not only the CPU but also the other computer devices, such as the host bus, GUI engine, South Bridge control engine . . . etc., into Power-saving state, has been proposed. The method includes the following steps: issuing a Power-saving related message; dropping the Power-saving related message, wherein a Power-saving related flag is not set; setting the Power-saving related flag; setting a VID/FID pending bit in the CPU, wherein the vertical blanking of the d display/displays occurs and clearing the Power-saving related flag, wherein the Power-saving related flag is set, and executing a power saving process. The Power-saving related flag may be built-in North Bridge, South Bridge or CPU.

### BACKGROUND OF THE INVENTION

1. Field of the Invention

The present invention relates to a power configuration scheme of the computer. More particularly, the present invention relates to a Power-saving method, which is able to configure not only the CPU but also the other components, such as the host bus, GUI engine, South Bridge control engine . . . etc., into Power-saving state by setting a Power-saving related flag.

2. Description of the Prior Art

It's well known that, the operation voltage and core frequency of a computer's CPU are not always constant but usually varied based on CPU utilization. Under busy condition, the CPU will change the frequency and voltage thereof to a high state for efficiently handling tasks, or they will be changed to a low state for saving more power as in the condition of low CPU utilization. A VID/FID changing message is a message issued by the CPU, which causes the power state transition of the CPU by changing the core frequency and operation frequency. In the following paragraphs, an example to show conventional CPU power state transitions (especially for the case of reducing voltage and frequency to save power) in the HyperTransport K8 environment is described. In order to make safeness of the VID/FID transitions, the host bus between CPU and NB has to be separated and resets their own configurations in VID/FID change time period. Thus, the SB has to control LDTSTOP# in support of VID/FID change. VID/FID transitions cause clocks of the CPU and host bridge to ramp down, the HyperTransport links is disconnected, and memory enters self-refresh state, to allow the core frequency and operation voltage of the CPU dynamically changing in the computer systems.

FIG. 1 shows the flow chart of the conventional Power-saving scheme. Firstly, the CPU accesses the advanced configuration and power interface (ACPI) register or issues a VID/FID broadcast message or to the North Bridge (NB) (step 100). Then, the NB will pass the broadcast message or the accessed ACPI register message directly to the South Bridge (SB) (step 102). In respond to the foregoing VID/FID message, the SB issues a stop clock (StpClk) assertion message with VID/FID SMAF (System Management Action Field) through the NB to the CPU (step 104). When CPU receives the StpClk message from the SB, the CPU issues a Stop Grant system management message (indicative of the host being ready to power state transition) to the NB (step 106), and NB transfers the Stop Grant message with SMAF down to the SB (step 108). he SB asserts SB_LDTSTOP# to force CPU and devices into VID/FID state (step 110), and the NB assert NB_LDTSTOP# to force CPU and devices into the VID/FID state (step 112), too. Then, the host link is disconnected (step 114). After a period of time, The SB may de-assert SB_LDTSTOP# and the NB may de-assert NB_LDTSTOP# to force the CPU out of VID/FID state. This is done by sending the LDTSTOP# message respectively to the CPU (step 116, 118). After the CPU receives the LDTSTOP# de-assertion message, the host link will be re-connected (step 120). And, after a period of time, the SB will issue the STPCLK de-assertion message up to the CPU (step 122), and the CPU will then make itself out of VID/FID state (step 124).

Accordingly, a power state transition of the CPU is accomplished. However, in view of aforementioned description, the conventional power transition scheme manages the CPU only, but not including of the other components in the computer system. That's because the CPU does not know the all the detailed control schemes of all the components involving in the computer system, so the CPU could not adjust their power state. To overcome this inconvenience, a new power transition scheme, especially a Power-saving scheme is proposed in the present invention.

### SUMMARY OF THE INVENTION

In view of the above descriptions, an object of the present invention is to provide a new method for proceeding the power transition of a computer system.

It is another object of the present invention to provide a method for configuring the power state of the computer system. More specially, not only the CPU, the present method also configures the other devices in the computer system.

It is still another object of the present invention for providing a Power-saving method in a computer system.

A Power-saving method in a computer system is provided in the present invention. The method includes the following steps: issuing a Power-saving related message. Check if currently the Power-saving related flag is set, wherein the method drops the Power-saving related message when the Power-saving related flag is not set. Then, a Power-saving related flag is set by setting a Power-saving related bit. The Power-saving related flag is cleared when a power saving process is executed. The Power-saving related flag may be built-in North Bridge, South Bridge or CPU.

### BRIEF DESCRIPTION OF THE DRAWINGS

Other objects, features, and advantages of the invention will become apparent from the following detailed description of the preferred embodiments with reference to the accompanying drawings in which:

FIG. 1 shows the flow chart of a conventional Power-saving scheme in a computer system;

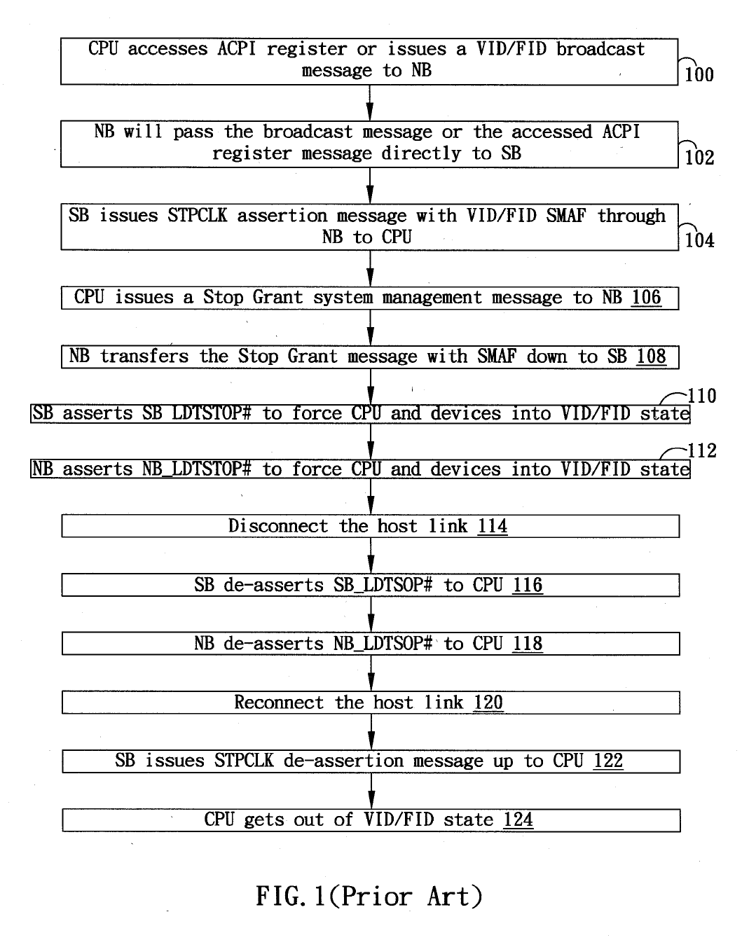

FIG. 2 shows the flow chart of the preferred embodiment of the present invention;

FIG. 3 shows the operation flow of the step 2-4 shown in FIG. 2; and

FIG. 4 shows the operation flow of the step 2-6 shown in FIG. 2;

### DETAILED DESCRIPTION OF THE PRESENT INVENTION

The present invention provides a new method for proceeding the power transition of the computer system, and more particularly relates to a Power-saving method for computer system. The preferred embodiments of the present invention will be described in detail and clearly as follows. Otherwise, for easily understanding and clarifying the invention, the parts of the illustration is not depicted in corresponding scale. Some scales and related ratio has been exaggerated, and the unrelated parts have not fully shown for the concise drawing. However, except for the detailed description, the invention can widely apply in others. And the invention is not limited here but the claims.

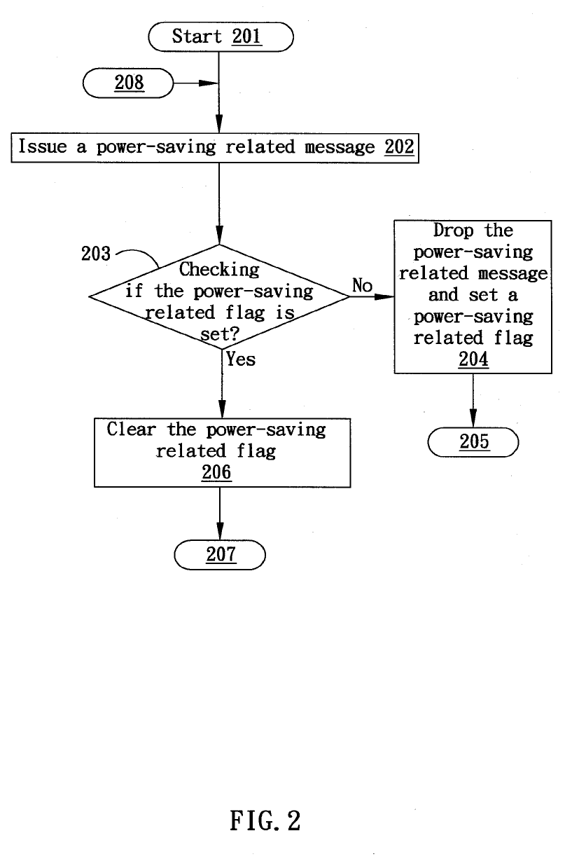

FIG. 2 shows the flow chart for proceeding the Power-saving process. It's noticed that the Power-saving scheme is one kind of the power state transition. The operation flow shown in FIG. 2 starts when a Power-saving related message (specially the VID/FID changing message) issued by the CPU. An obvious difference with the conventional method is, a Power-saving related flag is used to proceed the present method. And, the CPU will issue Power-saving related message twice for a complete Power-saving process. Detailed descriptions about the Power-saving process of the invention will be explained hereafter.

Referring to FIG. 2, while the computer is prepared to change its power state, especially the Power-saving state, firstly the CPU issues a Power-saving related message to initialize Power-saving process (step 202). The Power-saving related message may be a VID/FID change message. And next, the method checks if the Power-saving related flag is set (step 203) and accordingly proceeds suitable procedure. The Power-saving related flag is used to indicate the if a Power-saving related message is issued once by the CPU. In the other words, the Power-saving related flag is an indicator. In an embodiment, the Power-saving related flag is a register and is built-in the NB, which is used to avoid the Power-saving related message blocking other following requests from the CPU. According to the design issue, the peripheral component interface (PCI) programming rule is defined in the standard that all the requests in queue follow the first in first out (FIFO) rule. If the first request in queue cannot be consumed, the following requests cannot be executed. Hence, in the conventional power saving scheme of the computer, once the Power-saving related message issued by the CPU, the Power-saving scheme will be executed till finishing all procedure. By using the Power-saving related flag, it helps the NB remember that the CPU has issued a Power-saving related message, even if the NB drops the Power-saving related message (step 206).

In default, the Power-saving related flag in the NB is not set before the CPU issues the Power-saving related message. Hence, the proceeding flow will branch to step 204 and then go to step 205. In step 204, the NB drops the Power-saving related message and sets the Power-saving related flag. Since the Power-saving related message has been dropped in the NB, the SB will not know that the CPU has issued Power-saving related message and is prepared to enter Power-saving state. So, the computer system may execute other instructions/processes even if the Power-saving scheme is yet finished.

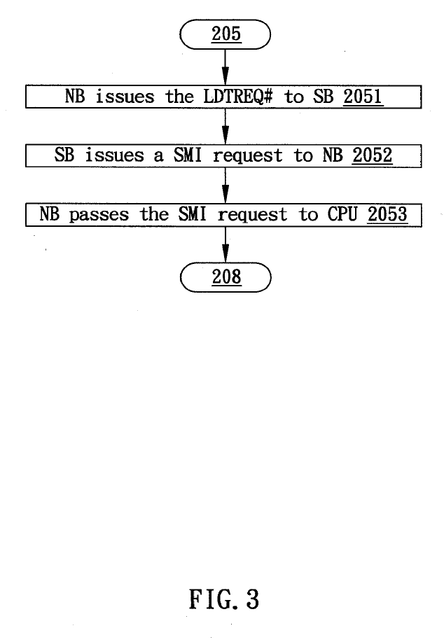

Details operations of the step 205 are shown in the FIG. 3. Unlike the conventional method, the NB issues a request to the SB via the LDTREQ# channel connected with the GPIO (General Purpose Input and Output) interface instead of transferring the Power-saving related message to the SB (step 2051). After receiving the request, the SB generates the SMI request to the NB (step 2052). The NB passes the SMI request directly up to the CPU to induce a SMI service routine (step 2053). According to the SMI service routine, the CPU will configure registers to adjust host bus frequency, the GUI engine, the NB's and the SB's control engines to appropriate power states according to current computer system conditions. So, the CPU could know the information of the other devices in the computer system and be able to configure them to appropriate power state for saving power. In the next, the process will return back to the step 208 shown in FIG. 2.

Not only configure the registers for configuring the other computer devices, the SMI request issued by the SB also makes the CPU re-issuing a VID/FID broadcast message (step 202). So, the NB receives the Power-saving related message again. This time, since the Power-saving related flag in the NB is set, which means the currently-issued Power-saving related message is not issued firstly, the method will branch to step 206 instead of step 204. Therefore, the method then transfers the Power-saving related flag to the SB, besides, the method also clears and resets the Power-saving related flag (step 206) to its default value (in other words, the Power-saving related flag returns being not set). Next, the process goes to step 207.

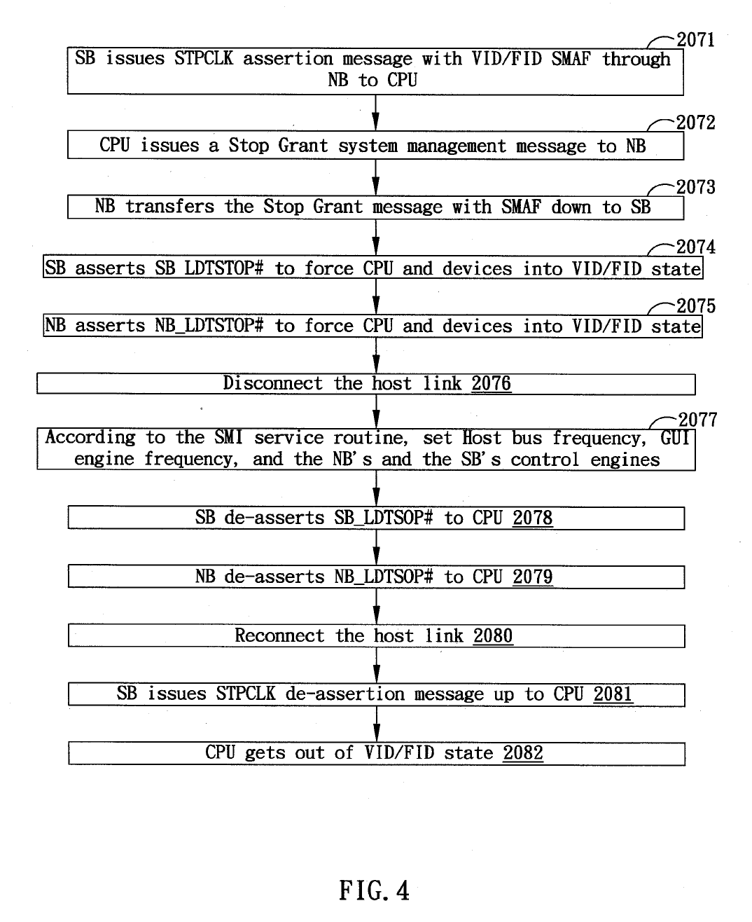

Referring to FIG. 4, herein shows the detail procedure from the step 207 for continuing the Power-saving process. The procedure shown in the FIG. 4 is very similar to the conventional method described in prior art. As well as the conventional method, in responsive to the issued Power-saving related flag (VID/FID changing message), the SB may issues the STPCLK assertion message (with VID/FID SMAF) through the NB to the CPU (step 2071). In after, in responsive to the StpClk assertion message, the CPU issues the Stop Grant system management message to the NB (step 2072), and then passes through the NB to the SB (step 2073). After the Stop Grant system management message is received, the SB may assert SB_LDTSTOP# and the NB may assert NB_LDTSTOP# to the CPU in a period of time (step 2074, 2075). So far, the SB and the NB are ready for entering Power-saving state, and the host links between the CPU and the NB and between the NB and the SB are ready to disconnect (2076). In next step, According to the SMI service routine, step 2077 shows the method will then set registers to configure the power state of the other computer devices, such as the Host bus frequency between the NB and the CPU, the GUI engine frequency (i.e., 2D, 3D, MPEG, video processor . . . etc.), and the frequency of the NB's or the SB's controller engines. By doing this step, the present Power-saving method of the present invention achieves the goals that not only the CPU, but also the interfaces between the CPU and chipsets and all the controller engines are changed for saving power.

After a specific time, the NB and the SB will re-link the host link. The SB will de-assert SB_LDTSTOP# message and the NB will de-assert NB_LDTSTOP# message to the CPU respectively to force the CPU and the other devices out of VID/FID state (step 2078, 2079). After receiving the all the LDTSTOP# de-assertion messages, the host link will be re-connected (step 2080). In the next step, the SB issues the STPCLK de-assertion message to the NB and the NB passes it to the CPU (2081). Finally, after the STPCLK de-assertion message is received by the CPU, the CPU then gets out of the VID/FID state (step 2082). Thus, the power can be saved.

It's noticed that, the Power-saving related flag may utilize one or more pending bits to indicate whether the Power-saving related flag is set. In one embodiment, the Power-saving related flag composes of only one bit, and the Power-saving related flag is regarded as being set when the bit is currently assigned to a binary “1” (or “0”). In an another embodiment, the Power-saving related flag may compose of several bits, and the Power-saving related flag will be regarded as being set when numbers of set bits exceed a pre-defined value (e.g. the Power-saving related flag includes 4 bits, and the flag is considered as “being set” if there are more than 2 bits assigned to binary “1”(or “0”)). Furthermore, the Power-saving related flag may record the numbers of the issued Power-saving related messages, and the flag is regarded as being set when the frequencies of the issued Power-saving related messages exceed a pre-defined times. It's therefore the ways indicative of whether the Power-saving related flag is set are not limited in the present invention.

Furthermore, step 202 shown the FIG. 2 could be a step for setting the advanced configuration and power interface (ACPI) register in NB if the system in an ACPI-defined system. In this case, the Power-saving related flag is used to avoid the ACPI access register blocking other following requests from the CPU. The following step 203 also checks the status of the Power-saving related flag after accessing the ACPI register.

Summarily speaking, it's obvious that the major principle of the present invention is: the computer system does not initial the Power-saving scheme immediately while receiving the CPU's Power-saving request. The key point lies on:
1. The NB will block and prevent the firstly-issued Power-saving related message of the CPU passing to the SB to initialize the Power-saving scheme at once; and
2. The computer system provides an additional process cycle for the CPU acquiring the information of the other computer devices and configuring their power states before actually executing the Power-saving scheme.

Although the description discloses the preferred embodiment herein, it is not limit the spirit of the invention. It is intended that the specification and examples to be considered as exemplary only, with a true scope and spirit of the invention being indicated by the following claims.

What is claimed is:

1. A Power-saving method comprises:
issuing a Power-saving related message;
checking a Power-saving related flag;
informing the CPU of a Power-saving mode;
clearing the Power-saving related flag if the Power-saving related flag is set; and
executing a power saving process.

2. The method according to claim 1 further comprising the step of dropping said Power-saving related message if said Power-saving related flag is not set.

3. The method according to claim 2, wherein the step of informing the CPU of the Power-saving mode is performed after said Power-saving related message is dropped.

4. The method according to claim 1, wherein the step of informing the CPU of the Power-saving mode is performed after a vertical blanking of a plurality of displays occurs.

5. The method according to claim 1, wherein said Power-saving related flag is regarded as being set when said Power-saving related flag is assigned to a pre-defined value.

6. The method according to claim 1, wherein said Power-saving related flag is regarded as being set when numbers of set bits of said Power-saving related flag exceed a pre-defined value.

7. The method according to claim 1, wherein said Power-saving related flag is regard as being set when numbers of the issued Power-saving related messages exceed a pre-defined time.

8. The method according to claim 1, wherein said Power-saving related message is a VID/FID change message.

9. The method according to claim 1, wherein said Power-saving related flag is a VID/FID pending flag.

10. The method according to claim 1, wherein the step of informing the CPU of the Power-saving mode further comprising:
setting said Power-saving related flag after dropping the Power-saving related message; and
setting a Power-saving related bit in the CPU.

11. The method according to claim 10, wherein said Power-saving related bit is a VID/FID pending bit.

12. The method according to claim 1, wherein said step of executing said power saving process further comprising:
issuing a STPCLK assertion message;
issuing a STOP GRANT system management message;
asserting a SB_LDTSTOP#;
asserting a NB_LDTSTOP#;
disconnecting a host link;
de-asserting a SB_LDTSTOP#;
de-asserting a NB_LDTSTOP#;
connecting said host link; and
issuing a STPCLK de-assertion message.
